(19) United States
(12) Patent Application Publication
(10) Pub. No.: US 2011/0164517 A1
(43) Pub. Date: Jul. 7, 2011

(54) COMPLEXITY MANAGEMENT IN A MULTI-USER COMMUNICATIONS SYSTEM

(76) Inventors: David Shepherd, Lyneham (AU); Mark Reed, North Lyneham (AU); Zhennig Shi, Lyneham (AU)

(21) Appl. No.: 12/989,938

(22) PCT Filed: Apr. 28, 2009
(86) PCT No.: PCT/AU2009/000528

§ 371 Date: Jan. 7, 2011

(30) Foreign Application Priority Data
Apr. 29, 2008 (AU) 2008902115

(51) Int. Cl. H04L 12/26

(52) U.S. Cl. 370/252

(57) ABSTRACT

The invention concerns complexity management of a receiver in a multi-access/user communication system where interference exists. For example, but not limited to, multi-user detection at the receiver in the uplink of a code division multiple access DS/CDMA system. The invention provides a method for power management and decoding schedule optimisation by deriving (40) an extrinsic information transfer (EXIT) function for an interference canceller and a plurality of decoders. Then, determining (42) a power level for each of the plurality of users based on the derived EXIT functions; and then deriving (44) a decoding schedule for the plurality of decoders based on the derived EXIT functions and determined power levels. It is an advantage of the invention that optimization is broken into two parts. There is no trade-off between computational complexity (number of iterations) and the improvement in bit error rate performance at a given signal-to-noise ratio. Using the invention, large gains in receiver sensitivity (i.e. in power efficiency and/or spectrum efficiency therefore reducing interference from the terminals) and computational complexity can be achieved simultaneously.

### TECHNICAL FIELD

The invention concerns complexity management of a receiver in a multi-access/user communication system where interference exists. For example, but not limited to, multi-user detection at the receiver in the uplink of a code division multiple access DS/CDMA system. Aspects of the invention include a method, a base station receiver and software.

### BACKGROUND ART

In recent years there has been much interest in multiuser cellular systems and receiver design for coded code division multiple access (CDMA) systems.

Predicting the performance of a CDMA system with iterative decoding is computationally demanding even for a small number of users. Extrinsic information transfer (EXIT) chart analysis has been successfully used for describing and visualizing the convergence behaviour without the need for computationally demanding simulations.

Decoding in an iterative multiuser detector (IMUD) receiver proceeds according to a schedule of activations of the component decoders and interference canceller (IC). Conventional IMUD receivers follow a fixed (static) decoding schedule.

### SUMMARY OF THE INVENTION

In a first aspect the invention provides a method for power management and decoding schedule optimisation at a base station in communication with a plurality of users in a wireless network, the method comprising the steps of:

(i) deriving an extrinsic information transfer (EXIT) function for an interference canceller and a plurality of decoders at the base station, each decoder being associated with a user;

(ii) determining a power level for each of the plurality of users based on the derived EXIT functions; and then

(iii) deriving a decoding schedule for the plurality of decoders based on the derived EXIT functions and determined power levels.

Joint optimization of the power and decoding schedule is prohibitively complex so it is an advantage of the invention that optimization is broken into two parts. Firstly, power levels of each user are optimised, and then the decoding schedule using the optimized power levels is determined. As a result there need not be any trade-off between computational complexity (number of iterations) and the improvement in bit error rate performance at a given signal-to-noise ratio. Using the invention, large gains in receiver sensitivity (i.e. in power efficiency and/or spectrum efficiency therefore reducing interference from the user terminals) and computational complexity can be achieved simultaneously.

The EXIT function may represent the transfer function of a group of users with different power, code rate or modulation. An effective EXIT function may be determined for the interference canceller of the base station. An effective EXIT function may be determined for a turbo decoder using Monte Carlo simulation. The EXIT function may have as input mutual information.

Step (i) may be based on predetermined or dynamic decoding statistics of all user groups.

Step (ii) may produce a power optimised EXIT chart that is then used in step (iii).

Step (ii) may be based on a convergence analysis of the EXIT chart, that is minimising a threshold given a total power by optimizing the distribution of power among the users. In particular, the optimisation may comprise using a nonlinear constraint function to derive the power allocation which includes the use of EXIT chart outputs.

The users may be divided into multiple groups where each member of the group has equal power. The method may further comprise treating a group as a single user.

Step (iii) may use both an off-line initialization and a on-line Viterbi search.

The off-line initialisation may comprise determining a convergence point which is the intersection of a decoder EXIT curve with a interference canceller EXIT curve, and then determining the convergence bit error rate P*=Q(J⁻¹(I_{D}*)/2) where P is the optimised power profile, Q(·) is the tail probability of the normalised Gaussian distribution, J( ) describes mutual information as a function of variance, and I*_{D} is the convergence point.

The Viterbi search may optimize the decoding schedule such that the decoding complexity and delay (total number of decoder iterations) are minimised while the bit error rate is maintained.

Complexity of step (iii) can be reduced by performing any one or more of:

trimming the trellis of a Viterbi search;

reducing the number of survivor paths of a Viterbi search

truncating the number of allowed decoder iterations, and

performing step (iii) less frequently than every iteration of the receiver.

The step deriving a decoding schedule may be derived initially or after a predetermined number of interference canceller activations.

Step (iii) may comprise both static and dynamic scheduling processes. The dynamic decoding schedule optimization may comprise deriving for each iteration of the receiver the optimal schedule to achieve a target bit error rate using a minimum number of decoder iterations. In the prior art, EXIT chart analysis based on an infinite block length results in a mismatch from trajectories simulated over a finite block length. This was observed in [4] where trajectory match was found to deteriorate over iterations. In [7] Li et al show an EXIT chart with confidence intervals and similarly, in [8] the authors propose a convergence analysis tool using a transfer characteristic band instead of a single transfer curve. Note that trajectory mismatch is not critical to convergence at high SNR, rather more so when operating close to the convergence threshold where the tunnel in the EXIT chart is narrow. This method of dynamic scheduling is able to compensate for the decoding trajectory mismatch.

Step (i) may further comprise deriving an EXIT function for a channel estimator. The decoding schedule of step (iii) may be further for the channel estimator.

The optimized receiver of at least one embodiment of the invention has a lower convergence threshold and requires less iterations to achieve convergence than a conventional receiver. Furthermore, at least one embodiment of the present invention results in a more consistent quality of service (QoS).

One advantage of at least one embodiment of the invention is that power optimized system using dynamic scheduling achieves similar bit error rate performance as a conventional receiver with significant complexity savings. Furthermore it outperforms the statically derived optimal schedule through reducing the variance of the per packet bit error rate.

In a second aspect the invention provides a base station for power and decoding schedule optimisation, the base station being in communication with a plurality of users in a wireless network, the base station comprising

an interference canceller;

a plurality of decoders, each decoder being associated with a user:

processing means to derive an extrinsic information transfer (EXIT) function for the interference canceller and the plurality of decoders at the base station;

a power optimisation module to determine a power level for each of the plurality of users based on the derived EXIT functions; and

a schedule optimisation module to determine a decoding schedule for the plurality of decoders based on the derived EXIT functions and determined power levels.

The base station may further comprise a plurality of channel estimators, each channel estimator associated with a resolvable path. The processing means may further operate to derive the EXIT function for the channel estimators and the schedule optimisation module may determine the decoding schedule also for the channel estimators based on the derived EXIT functions and the determined power levels.

In a third aspect, the invention provides software, that when installed is able to cause the base station to perform the method described above.

In a fourth aspect the invention provides a decoding schedule derived in accordance with the method described above.

### BRIEF DESCRIPTION OF THE DRAWINGS

An example of the invention will now be described with reference to the following drawings, in which:

FIG. 1(a) is a schematic diagram of an iterative multiuser detector (IMUD) receiver having control blocks (power and schedule optimisation);

FIG. 1(b) is a flow diagram showing an example of the method of the invention;

FIG. 1(c) is a schematic diagram of the receiver that consists of an interference canceller, plurality of channel decoders and plurality of channel estimators;

FIG. 2 is a graph showing the power optimisation algorithm trajectory for random starting points (using brute force search);

FIG. 3 is a chart showing the EXIT chart for the power optimised system K=[20,20,20], N=30, and P=[1, 1.5381, 2.3917] at P_{ref}/N₀=1.06 and 3.95 dB, and a snapshot trajectories at P_{ref}/N₀=3.95 dB.;

FIG. 4 is a schematic diagram showing the decoding trellis for two groups, where each state correspond to activating a receiver component (IC or TD_{k,i} where k is power-level group and is the number of iterations);

FIG. 5 is a graph showing the EXIT chart for equal power K=60, N=30 system at P_{ref}/N₀=9.15 and 17 dB (the 4-th iteration threshold);

FIG. 6 is a graph showing the BER performance of unequal power CDMA system K=[20,20,20], P=[1, 1.5381, 2.3917] and N=³ for IMUD receiver following dynamic, static and full decoding schedules;

FIG. 7 is a graph showing the complexity of unequal power CDMA system K=[20, 20, 20], P=[1,1,5381,2.3917] and N=30 for IMUD receiver following the dynamic, static and full decoding schedules;

FIG. 8 is a graph showing the average SNR vs total complexity for power, schedule (and combined power/schedule) optimization, using a target BER of 10⁻⁴.

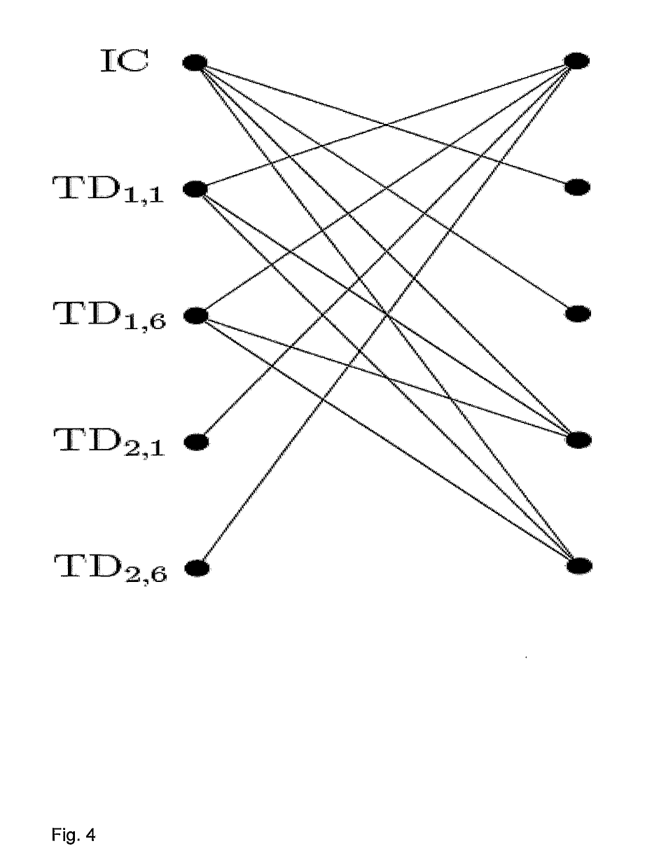

Table I is a sample look-up table for K=[20,20,20], N=30, P=[1.5381,2.3917], where each schedule represents a path through the trellis for FIG. 4.

### BEST MODES OF THE INVENTION

The iterative receiver of this example is a turbo coded multiuser DS-CDMA system. For the basic system model we refer the reader to [11].

There are K transmitters generating independent data symbols xₖε{−1,1} which are turbo encoded. The turbo code is 3GPP compliant, common for all users and consists of symmetric parallel concatenated 8-state convolutional codes with generator polynomial (Gᵣ,G)=(015, 013). The trellis is terminated in the encoders and the overall code rate is R=1/3 (no puncturing) and information block lengths range from 40 up to 5114 bits [12]. We use 3856 bits for all simulations in this description. The coded data dₖε{−1,1} is interleaved and spread by direct-sequence spreaders sₖε{−1/\sqrt{N}+1/\sqrt{N}} where N is the processing gain (spreading factor). The outputs are mapped onto BPSK symbols, while the work in this specification can be analogously applied to higher-order modulation. The received signal is

$$y = {\sum }_{k = 1}^{K} \sqrt{{P}_{k}} {s}_{k} {d}_{k} + n , \qquad ( 1 )$$

where Pₖ is the power of user k and n is AWGN noise with variance N₀/2. The optimization techniques described in this specification are general and can be extended to the multipath fading channel.

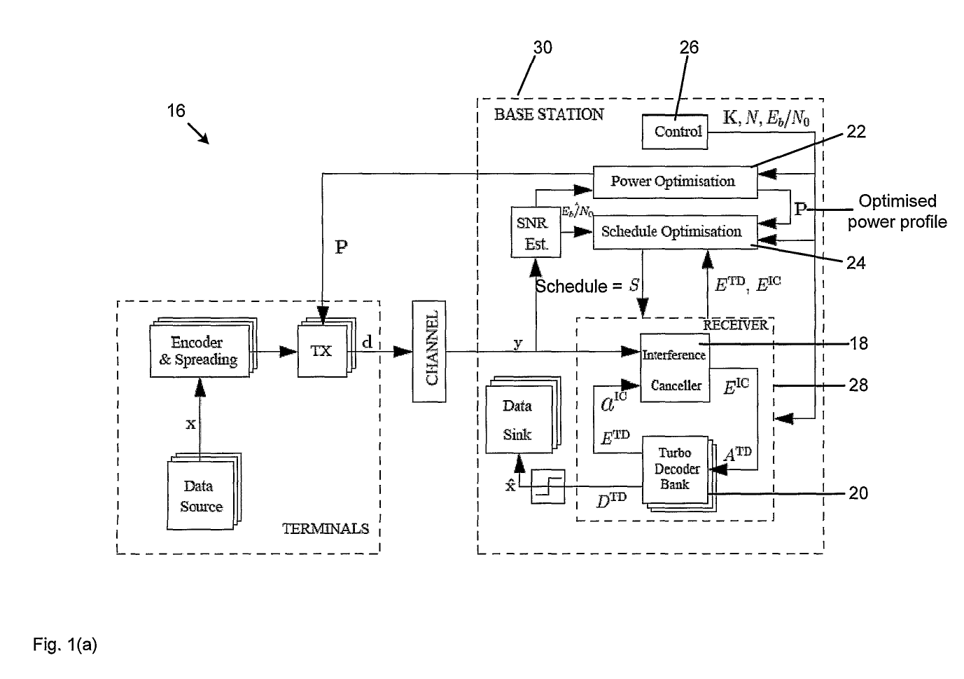

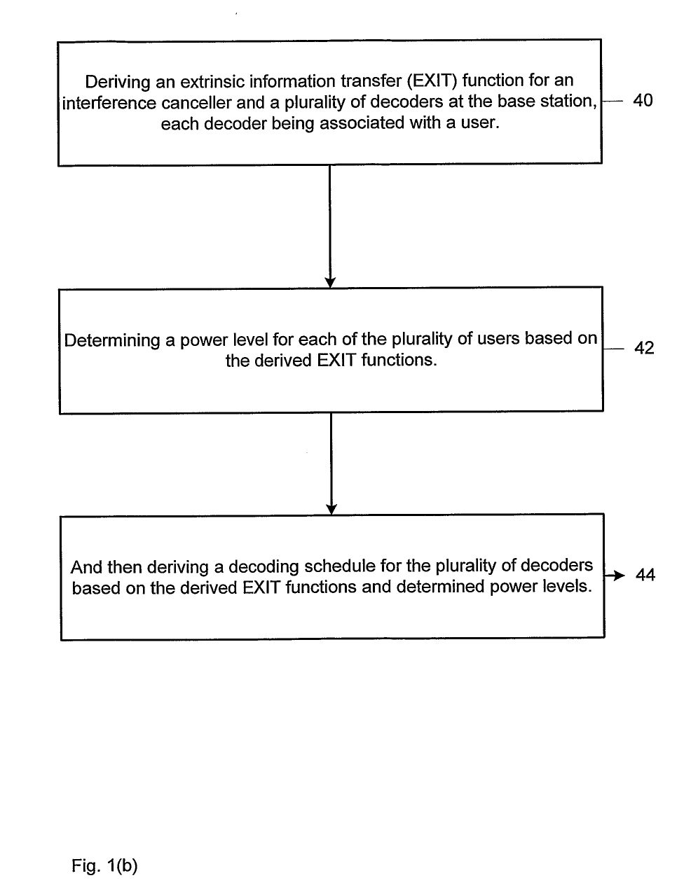

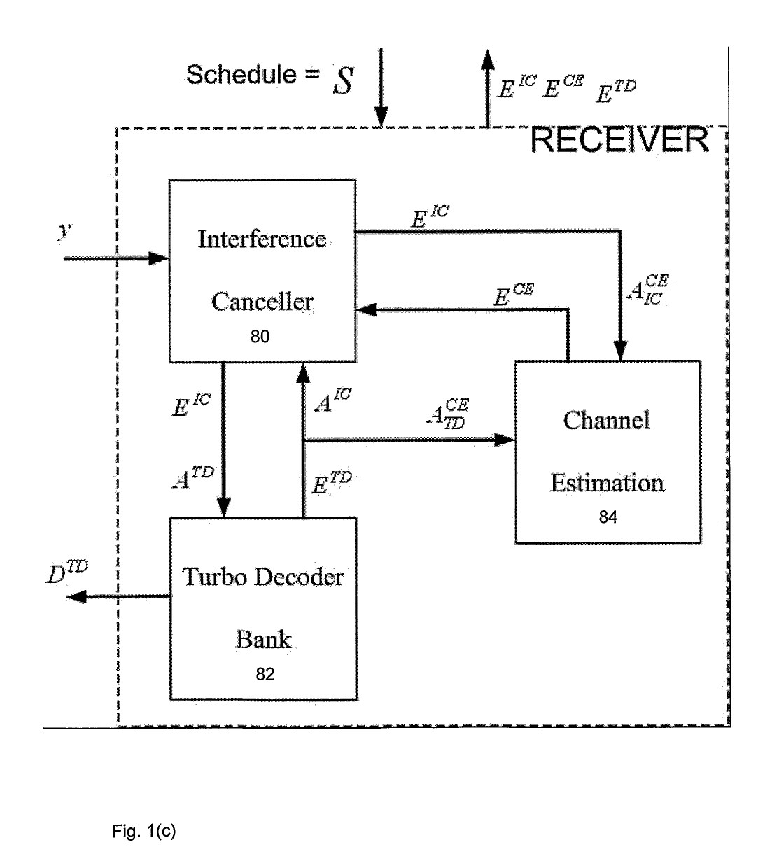

The IMUD receiver 16, shown in FIG. 1(a), consists of an IC 18 and K TDs 20 and was first described for convolutional codes in [11]. See [4] for a good description of the turbo decoder. The IC 18 takes as inputs the channel values y and a priori information a^{IC}k (from each of the K users k=1, 2, . . . , K) and outputs extrinsic information (on the coded bits for each user) Eₖ^{IC} which is de-interleaved and becomes the a priori input Aₖ^{TD} to the TD 20 for user k. On the first iteration of the receiver the a priori input to the IC 18 is zero. Each of the K TDs 20 outputs extrinsic information (on the coded bits) Eₖ^{TD} and a posteriori output (on the information bits) Dₖ^{TD}. Eₖ^{TD} is interleaved and converted to soft bits aₖ^{IC}=tan h(Eₖ^{TD}/2). Hard decisions are made on Dₖ^{TD}. Uppercase symbols are used to denote a log-likelihood ratio (LLR) and lowercase for soft bits.

A full version of receiver is shown in FIG. 1(c). The receiver consists of the interference canceller 80, a plurality of decoders (i.e. turbo decoder) 82 and a plurality of channel estimators 84. In addition to the extrinsic information exchanged between the interference canceller 80 and the turbo decoder 82, the detected or estimated information A_{TD}^{CE}, A_{IC}^{CE}(E^{IC}) and E^{CE} is exchanged between the three building blocks 80, 82 and 84.

In this example an explicit extrinsic information transfer (EXIT) function derives for a generic channel estimator over fading channels, where explicit means that the channel estimator EXIT is developed such that the output E^{CE} is a function of inputs A_{IC}^{CE} and A_{TD}^{CE}. The channel estimator EXIT chart is parameterized on a priori information from the multi-user detector 16 and decoders 82. The channel estimator EXIT function shows the reliability of the channel estimation over the time-varying channel. The dynamic decoding schedule may include channel estimator EXIT in the dynamic scheduling to:
optimize iterative performance by including channel decoding information in the channel estimation at different decoding iterations; and
determine whether to perform channel estimation at each decoding iteration to achieve the optimal performance and complexity tradeoffs.

The block diagram of the receiver 16 also comprises the control blocks—Power Optimization 22, Schedule Optimization 24 and the overall Control block 26 which passes information such as number of users and spreading factor to each receiver block. Note that we have omitted the subscript k for a priori and extrinsic data and have not shown the interleaver/deinterleaver between the IC 18 and TD 20. The Power Optimization module 22 passes the optimized power profile P to the transmitter and Schedule Optimization module 24. The optimal schedule information S generated by the Schedule Optimization module 24 is passed to the receiver 26.

The method of power management and decoding schedule optimisation (not including channel estimation) will now be described with reference to the flow chart of FIG. 1(b).

Initially an EXIT function is derived 40 for the IC 18 and a plurality of decoders 20 by processing means at the base station 30, where each decoder 20 is associated with a user k.

Next, a power level for each of the users K is determined 42 by a power optimisation module based on the EXIT function. For each input data block the power levels are optimized for the load and channel conditions. After transmission through the channel the noisy transmitted data is fed to the IC 18.

Next a decoding schedule is determined 44 by a schedule optimisation module for the plurality of decoders 20 based on the derived EXIT functions and the determined power levels. That is, after interference cancellation the dynamic schedule algorithm described below is run to estimate the optimal decoding schedule given the (estimated) point at which the decoding currently lies on the receiver EXIT chart.

The scheduling algorithm may then be called upon after any subsequent IC activations, depending on the degree of trajectory mismatch. The major advantage of dynamic scheduling over static scheduling is that the method compensates for performance better/worse than expected (average) due to differences in channel conditions over decoding blocks, or differences in the decoding trajectory. Using dynamic scheduling we have a more reliable receiver for similar complexity.

EXIT chart analysis will now be discussed in detail. Consider a CDMA system with L groups of different power levels. Define K=[K₁, K₂, . . . K_{L}] and P=[P₁, P₂, . . . P_{L}], where Kₖ and Pₖ are the number of users in the group k and their transmission power, respectively, for k=1, 2, . . . , L. The total number of users in the system is given by

$${K}_{T} = {\sum }_{k = 1}^{L} {K}_{k} . \qquad ( 2 )$$

We model the receiver blocks using variance and extrinsic information transfer (EXIT) functions. In an unequal power CDMA system the users are grouped according to their power level. We assume all users within a power group are essentially identical and we therefore consider each group as a (virtual) single user. For convergence analysis, the traditional EXIT charts need to be adjusted to reflect the behaviour of the system under the unequal power conditions [9], [14]. We assume hereafter the probability density functions of the input and output of the receiver blocks are Gaussian.

We utilize the J function, which describes mutual information as a function of variance, from [4] where

$${I}_{Λ} ( {σ}_{A} ) = J ( {σ}_{Λ} = σ ) = 1 - {\int }_{- ∞}^{+ ∞} {log}_{2} ( 1 + {e}^{- ξ} ) \frac{1}{\sqrt{2 π {σ}_{A}^{2}}} {e}^{\frac{- ( ξ - {σ}_{A}^{2} / 2 ) 2}{2 {σ}^{2}}} d ξ \qquad ( 3 )$$

and ξ are the samples of Λ. Note that

$$Λ = \frac{{σ}_{Λ}^{2}}{2} d + {h}_{Λ} \sim ( 0 , {σ}_{Λ}^{2} )$$

and σ_{Λ}²=4/σ_{λ}² where σ_{λ}² is the variance of the soft information λ.

An effective EXIT function refers to a single EXIT function defined for a system consisting of multiple users. Original EXIT function can be derived for each user. The benefit of using one effective EXIT function rather than multiple EXIT functions (for all users) is to reduce the dimension of the studied problem. For the interference canceller, the effective EXIT function is [6]

$$\begin{matrix}{I}_{E , eff}^{IC} = {f}_{mud} ( {I}_{A , eff}^{IC} , {E}_{b} / {N}_{0} ) \\ = J ( \sqrt{\frac{4}{( 1 - {T}^{- 1} ( {I}_{A , eff}^{IC} ) ) \frac{{K}_{eff} - 1}{N} + \frac{{N}_{0}}{2 {RP}_{ref}}}} )\end{matrix} \qquad ( 4 )$$

where I_{A,eff}^{IC}=I_{E,eff}^{TD} is the effective prior mutual information for the IC (the extrinsic information from the TD),

$${K}_{eff} = \frac{1}{{P}_{ref}} {\sum }_{k = 1}^{L} {K}_{k} {P}_{k}$$

is the effective number of users, P_{ref} is some arbitrary reference power level (unless otherwise specified, P_{ref}=P₁=E_{b}), N is the processing gain, R is the code rate and T(·) is the transfer function from [15] which describes mutual information I as a function of fidelity M=E{(x−\dot{x})²},

I=T(M)≈0.74M+0.26M². (5)

I_{E,eff}^{IC} is estimated online from the IC output using [14], [15]

$${\hat{I}}_{E , eff}^{IC} = J ( \sqrt{\frac{4}{\frac{1}{L} {\sum }_{k = 1}^{L} {σ}_{k , E}^{2}}} ) \qquad ( 6 )$$

where σ_{k,E}²=var(eₖ^{IC}) is the variance of the soft output of the IC. Note that the LLRs passed to the TD are generated as Eₖ^{IC}=2Pₖeₖ^{IC}/var(eₖ^{IC}).

We generate the EXIT chart for the TD, I_{E}^{TD}=f_{dec}(I_{A}^{TD}), using Monte Carlo simulation with P_{ref}=1. The effective EXIT function for group k with power Pₖ is then

$${I}_{E , k}^{TD} = {f}_{dec} ( J ( \sqrt{\frac{{P}_{k}}{{P}_{ref}}} {J}^{- 1} ( {I}_{A , eff}^{TD} ) ) ) , \qquad ( 7 )$$

where I_{A,eff}^{TD}=I_{E,eff}^{IC} is the effective prior mutual information for the TDs. We estimate I_{E,k}^{TD} and I_{D,k}^{TD} online using [16]

$${\hat{I}}_{Λ , k}^{TD} = 1 - 2 E \{ \frac{{log}_{2 } ( 1 + {e}^{- {Λ}_{k}^{TD}} )}{1 + {e}^{- {Λ}_{k}^{TD}}} \} , \qquad ( 8 )$$

where Λ is E or D. The effective mutual information of the extrinsic output of the K TDs is calculated as [6]

$${I}_{E , eff}^{TD} = 0.74 [ 1 - {\sum }_{k = 1}^{L} {α}_{k}^{*} ( 2.42 - \sqrt{2.03 + \frac{{I}_{E , k}^{TD}}{0.26}} ) ] + {0.26 [ 1 - {\sum }_{k = 1}^{L} {α}_{k}^{*} ( 2.42 - \sqrt{2.03 + \frac{{I}_{E , k}^{TD}}{0.26}} ) ]}^{2} . \qquad ( 9 )$$

Now using (7) and (9) we express the effective TD EXIT chart as

I_{E,eff}^{TD}=f_{dec}*(I_{A,eff}^{TD}). (10)

Note that we derive the EXIT chart of the TD for i^{d}ε(1, 2, . . . iₘₐₓ^{d}) iterations where iₘₐₓ^{d} is the maximum number of TD iterations. We also derive the EXIT function of the TD considering only the systematic bits, denoted by E(s), which we use for bit-error-rate (BER) estimation. We have observed a small difference between I_{E(s)}^{TD} and I_{E}^{TD}.

In this specification we focus on unequal power CDMA. However, the techniques described can be extended to systems utilizing adaptive modulation and coding, MIMO, IDMA, OFDM, and OFDMA. EXIT charts have been used for irregular codes in [17] for example, where a system was optimized by the selection of codes from an ensemble of different rate codes. In [18] EXIT charts were used to optimize bit-interleaved coded irregular modulation. The key concept is the ability to construct effective EXIT functions, that is a single EXIT function to represent the transfer function of a group users with different power, code rate, or modulation.

The step 42 of determining the power level of each of the users is determined based on the EXIT function. For a mobile system operator power optimization has the following benefits;
longer battery life in user terminal
less interference allowing larger cell sizes
more users per cell.

We therefore want to minimize the sum power of all users, which we address in this section. In multi-user CDMA system the convergence threshold, i.e. the SNR at which all users can decode successfully, depends on the power profile of the users. We consider a 3GPP compliant system where users can be grouped according to their power levels. Given the number of users K=[K₁, K₂, . . . , K_{L}] in L groups with spreading factor N, we propose a method to minimize the total power under the constraint that the system must converge. This approach essentially minimizes the convergence threshold given a total power by optimizing the distribution of power among the groups.

Once the IMUD receiver has been modelled using effective EXIT charts we are able to optimize the power levels of each group of users. Define the vector z=[0,δ, . . . , 1−δ,1] where δ<<1 is arbitrarily selected for resolution and the entries of Z correspond to the MI I_{A,eff}^{IC}=I_{Eeff}^{TD}, such that

I_{E,eff}^{IC}=f_{mud}(z) (11)

I_{A,eff}^{TD}=f_{dec}*⁻¹(z) (12)

where MI is the mutual information and zεz. We can use (11) and (12) to observe the (predicted) convergence properties of the transfer chart. That is, we can use sgn(f_{mud}(z)−f_{dec}*⁻¹(z)) to determine whether the transfer curves intersect and ∥f_{mud}(z)−f_{dec}*⁻¹(z)∥ to calculate the width of the tunnel. The optimization determines the power allocation which minimizes total transmit power given that a tunnel must be open in the EXIT chart such that iterative decoding can proceed until all multi-access interference (MAI) is removed.

We define the cost function as

$$F ( P ) = {{\sum }_{k}}^{L} {K}_{k} {P}_{k} \qquad ( 13 )$$

where the goal of the optimization is to minimize F(P). That is

$$subject to {\{ \begin{matrix}{b}_{l} < {P}_{k} < {b}_{u} , & ∀ k \\ c ( P ) \leq 0 & \end{matrix}}^{{m i n}_{P} F ( P ) }$$

where bₗ and bᵤ are the lower and upper bounds (respectively) imposed on the optimization variable P by the receiver and c(P) is the nonlinear constraint function

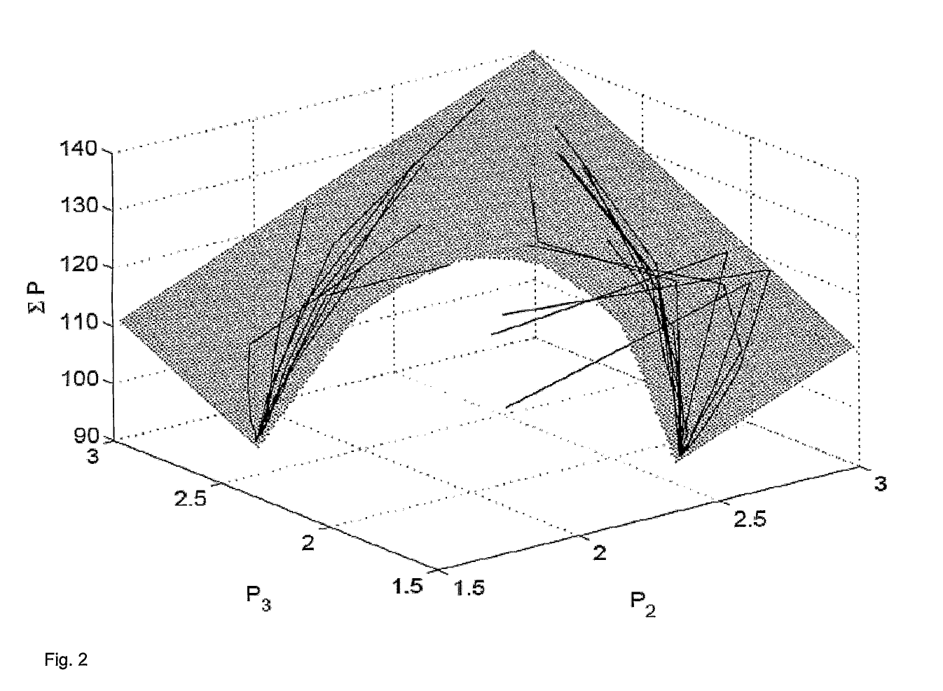

c(P)=f_{mud}(z)−f_{dec}*⁻¹(z)+Δ (14)

where Δ is an arbitrary scalar which represents the open tunnel between the two transfer curves. We show in FIG. 2 a map of the optimization space obtained through a brute-force search over all possible power profiles for a 3 power-group (K=[20,20,20] and N=30) system where P₁=P_{ref}=1. The inclined plane represents the set of points where the power profile allows successful decoding (open tunnel in the EXIT chart). We also show the trajectory of the algorithm for the power optimization (using random start points) using an optimization algorithm based on the interior-reflective Newton method [19], [20] and we see that the optimization converges on 2 solutions.

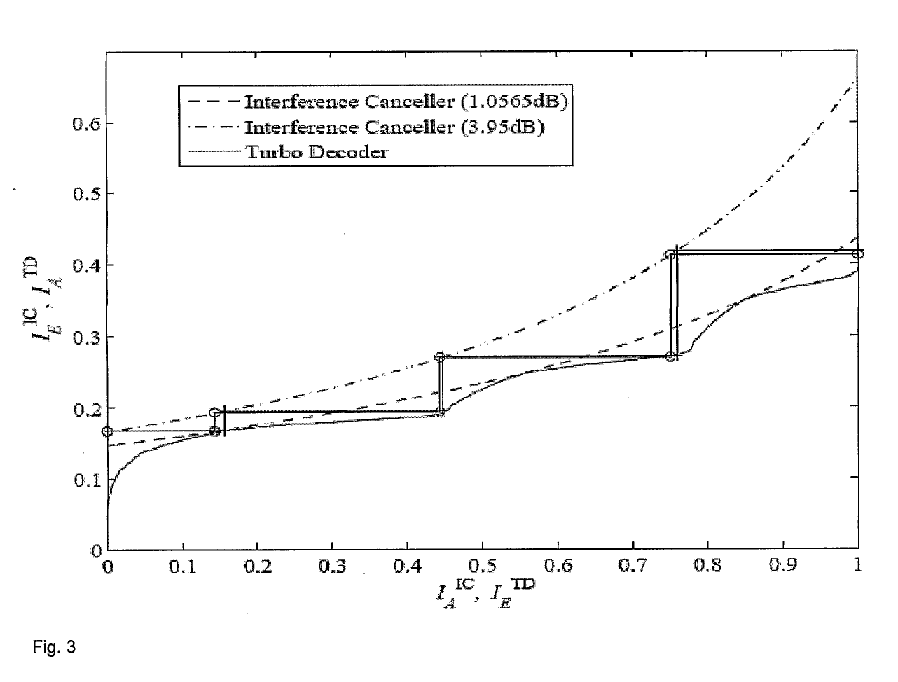

FIG. 3 shows the EXIT chart for a power-optimized unequal power CDMA system, K=[20,20,20] and N=30 we see that the EXIT curves match quite closely. The average SNR Ē_{b}/N₀ is 2.95 dB (P_{ref}/N₀=1.06 dB) at the solution P′=[1, 1,5381, 2,3917] shown by the dashed line (IC) and solid line (TD).

Now the step of determining a decoding schedule 44 will be described in more detail. The activation order, or scheduling, of receiver components is essential in the design of an iterative receiver with multiple concatenated components. We adapt a trellis-based Viterbi search optimization algorithm for unequal power CDMA to optimize the decoding schedule such that the decoding complexity and delay (total number of TD iterations) are minimized while BER performance is maintained. The search algorithm is generalized for use in all concatenated receivers as it is able to account for an arbitrary starting point (I_{A,eff}^{IC}≠0) and the cost function is two-dimensional. A decoding trellis is shown in FIG. 4 for a CDMA system with two groups where each group can run either 1 or 6 iterations of the TD. The subscripts in TD_{k,i} denote power-level group (k) and number of turbo decoding iterations (i). Each state in the trellis corresponds to activating the component represented by that state.

Note that the trellis can be fully connected, however the trellis in FIG. 4 is trimmed to reduce the complexity of the scheduling algorithm. We have manually removed redundant edges, such as from state 1 to state 1 (IC-IC), which achieve no gain in MI and would be removed by the algorithm itself. We derive the optimal schedule on each iteration of the receiver to compensate for differences between the predicted and actual EXIT chart trajectories.

### A. Static Scheduling

If the optimal schedule is derived off-line over a range of P_{ref}/N₀ values, the decoding schedule can be determined in two ways;
use the optimal schedule at the convergence threshold for all SNR
estimate the SNR online and use a look-up table to select the optimal schedule.
   The first option assumes only that the system configuration (K, N and P) is known. The latter has the additional requirement that SNR be estimated. See Table I for an example of a schedule look-up table. Noting in (4) that the SNR is needed to derive the IC EXIT chart, we propose a novel method of estimating the SNR in the AWGN CDMA channel. We first estimate the MI at the output of the IC I_{E,eff*}^{IC} using (6), after the first activation of the IC. Note that the first activation of the IC involves no cancelation and E^{IC} is simply the match-filtered channel output. The SNR can then be estimated as

$$\frac{{P}_{ref}}{{N}_{0}} \approx {( 2 R ( \frac{4}{{{J}^{- 1} ( {I}_{E , eff}^{IC} )}^{2}} - \frac{{K}_{eff} - 1}{N} ) )}^{- 1} , \qquad ( 15 )$$

which we obtained using (4).

### B. Dynamic Scheduling

Alternatively the schedule can be derived dynamically to compensate for variations in the decoding trajectory. EXIT charts assume the interleaver depth is large so when small block lengths are used there is mismatch between the expected and simulated trajectories [4]. The schedule can be dynamically derived following every x^{th} IC activation. The frequency of schedule refining depends upon the degree of variation in the decoding trajectory. Some decision criteria can be used to determine whether the mismatch is sufficient to require refining of the schedule, for example deviation from the expected I_{D}, where

I_{D}=J(\sqrt{J⁻¹(I_{E,eff}^{IC})²+J⁻¹(I_{E,eff}^{TD})²}). (16)

can be used as a measure to determine if the modification on the current decoding scheme is needed.

### C. Notation

Let m denote trellis transition. Each group is permitted i^{d}ε{1, 2, . . . , iₘₐₓ^{d}} iterations. Paths entering state n are defined as Pᵣ=(p₁, p₂, . . . , pₘ) where rε[0,∞) is the path number, pⱼε{1, 2, . . . iₘₐₓ^{d}L+1} for 1≦j≦m−1 and pₘ=n. The metric for the corresponding path is represented as v=(v₁, v₂, . . . , v_{2L+4}), which we define as

v=(\hat{P}_{b,1}, . . . , \hat{P}_{b,L},C^{IC},C^{TD},I_{E,eff}^{IC},I_{E,eff}^{TD},I_{E,1}^{TD}, . . . , I_{E,L}^{TD}) (17)

where complexity C^{IC} is the number of receiver iterations (IC activations) and C^{TD} is the total number of TD iterations. Complexity is updated as

$$\begin{matrix}{C}_{m}^{IC} = {C}_{m - 1}^{IC} + \{ \begin{matrix}1 & for an IC activation \\ 0 & otherwise , \end{matrix} & ( 18 ) \\ {C}_{m}^{TD} = {C}_{m - 1}^{TD} + \{ \begin{matrix}{i}^{d} & for a TD activation \\ 0 & otherwise , \end{matrix} & ( 19 )\end{matrix}$$

where i^{d} is the number of TD iterations. The receiver is permitted i^{r}ε{1, 2, . . . iₘₐₓ^{r}} iterations.

Note that the complexity metric is two-dimensional in contrast to one-dimension in [5]. This is due to our constraint on i^{r}.

Let I_{D,k} denote the mutual information of the a posteriori output from TD group k. It can be calculated as

I_{D,k}=J({square root over (J⁻¹(I_{A(s),k}^{TD})²+J⁻¹(I_{E(a),k}^{TD})²)}) (20)

where A(s) and E(s) denote the a priori and extrinsic mutual information of the systematic bits, respectively. The expression in (20) can be used to estimate the BER of group k as [4]

\hat{P}_{b,k}=Q(J⁻¹(I_{D,k})/2), (21)

which are the L first elements in (17). Since σ_{D}²=σ_{A}²+σ_{E}², point on the EXIT chart at which a paths trajectory finishes is described by I_{D} in (16), which we can use as a single metric to gauge path performance in complexity saving techniques which are described in with the simulation results below. The convergence point I_{D}* in (16), which we can use as a single metric to gauge path performance in complexity saving techniques which are also described in the simulation results below. The convergence point I_{D}* is the point where the IC and TD EXIT functions intersect and the corresponding BER is P*=Q(J⁻¹(I_{D}*)/2) where P is the optimised power profile, Q(·) is the tail probability of the normalised Gaussian distribution, J( ) describes mutual information as a function of variance defined in (3), and I*_{D} is the convergence point.

The sets of surviving paths and metrics are denoted by Pₘ and Vₘ respectively; and P_{m,n} [symbol] Pₘ and V_{m,n} [symbol] Vₘ are the sets of paths and metrics ending at state n after m trellis transitions. The current (at transition m) optimal path P* has metric v*. The number of paths in Pₘ is denoted by R.

The start point of the algorithm is determined using the metric initialization function fᵢₙᵢₜ(Eₖ^{IC},Eₖ^{TD},Dₖ^{TD}), wherein I_{E,eff}^{IC} is updated using (6), I_{E,k}^{TD} and I_{D,k}^{TD} using (8) and E_{E,eff}^{TD} using (9). This is done on-line after activation of the IC using the current Eₖ^{IC}, Eₖ^{TD} and Dₖ^{TD}. Note that performance of the algorithm is highly dependent upon the reliability of the output of fᵢₙᵢₜ which defines the point on the EXIT chart from which the decoding path begins. If fᵢₙᵢₜ overestimates mutual information the schedule will not allocate sufficient iterations and vice versa.

The metric update function fₙ(I_{E,eff}^{IC},I_{E,k}^{TD},i^{d}), for each state n [5], is used to update the 2L+4 elements in v for all paths entering state n using (4), (7), (9), (21) and (19). This function uses look-up tables (of the receiver block EXIT functions) to estimate the path's trajectory on the EXIT chart corresponding to the transition through the trellis.

We define domination as in [5], where metric v dominates v′ if and only if the extrinsic mutual information v_{q} are higher than v_{q}′ for q=L+3,L+4, . . . , 2L+4, respectively, and the complexities v_{q} are less than or equal to for q=L+1,L+2. Define target BER P_{target} as the desired BER of each group of users.

### D. Algorithm

The algorithm is divided into 2 parts—an off-line initialization and the on-line Viterbi search. The initialization procedures are as follows

1) Derive the EXIT chart for the load/power/SNR configuration of interest using the results above (note that I_{E}=f_{dec}(I_{A}) must be generated using Monte Carlo simulation)

2) Determine the convergence point I_{D′}* the intersection of the TD EXIT (for iₘₐₓ^{d} iterations) curve with the interference canceler curve

3) Calculate the convergence BER P*=Q(J⁻¹(I_{D}*)/2)

The Viterbi search algorithm is as follows

1) Let m=1. Initialize path set to contain only one path P={(1)} and corresponding metric set vₘ={fᵢₙᵢₜ}. Initialize p*=1 and v_{L+1}*=∞.

2) m=m+1, calculate the number of paths R in Pₘ. For each state n′ extend each path Pᵣ′ ending in state n′ along the trellis defined transition n′→n, producing the new path P_{R+1} in P_{m,n}, update the metric in V_{m,n} using v=fₙ(v′) and increment R.

3) Remove all paths with complexity greater than or equal to that of the current optimal path p*.

4) Define a set of metrics V* for paths that have reached the target BER (v_{q}≦P_{target}, ∀ q=1, 2, . . . L). the convergence point I_{D}* or iₘₐₓ^{r} receiver iterations. If there are multiple paths in V* replace the candidate path P* with the path of the lowest complexity.

5) For each state, eliminate dominated metrics and their corresponding paths. If P*<P_{target} eliminate paths in V* with any (\hat{P}_{b,1}, \hat{P}_{b,2}, . . . \hat{P}_{b,L})>P_{target}.

6) If no paths remain in Vₘ the candidate path P* is the optimal path. Otherwise go to step 2.

### E. Complexity

One factor to consider is the complexity of the scheduling algorithm in comparison to the complexity savings realized. With a large number of groups N_{K} and a large number of TD iterations (i^{d}) the number of states and surviving paths in the trellis can grow large. Though it is possible that the number of surviving paths in the algorithm grows exponentially, this has not been observed in practice.

The number of states in the trellis is N_{R}=vᵢ^{d}Nₖ+1, where vᵢ^{d} is the number of allowed TD iterations i^{d} (e.g. vᵢ^{d}=6 when i_{d}ε{1,2, . . . 5,6}), and the number of trellis transitions N_{T} is iₘₐₓ^{r}(N_{K}+1). The complexity of the scheduling algorithm is approximately

O(Nₛ^{N}^{_{T}}) (22)

in the worst-case scenario, that is assuming no paths are removed in the domination step. With typical parameters iₘₐₓ^{r}=4, i^{d}ε{1, 2, . . . , 6} and N_{K}=3 the scheduling algorithm has complexity in the order of 10²⁰. While the domination step generally ensures the complexity does not grow exponentially, the complexity of the scheduling algorithm is an issue, and the following measures can assist in resolving the complexity problem:
trimming the trellis (remove redundant edges)
reducing the number of survivor paths (e.g. keep only paths with I_{D}≦x·I_{D}^{max} where xε{0,1}) as in the T-BCJR algorithm [21]
limiting the number of survivor paths (e.g. keep only best x paths ranked in order of I_{D} (16)) as in the M-BCJR algorithm [21]
truncating the number of allowed TD iterations i^{d} to some subset of i^{d}
running scheduling algorithm every x^{th} receiver iteration where x>1

For all work in this specification we utilize a trimmed trellis as shown in FIG. 4, where redundant edges have been removed and the system is forced to activate TDs in order (i.e. group 1, 2, . . . , N_{K}). We use this approach alone, as it has no detrimental effect on the algorithm as the groups are independent. Known methods may result in a sub-optimal schedule being selected. The T-BCJR algorithm is known to give near-optimum performance but fails to reduce worst-case complexity, while the M-BCJR algorithm reduces worst-case complexity but suffers from performance degradation [22]. Using a trimmed trellis the complexity is approximately

O(Nₛ·β^{N}^{_{T}}⁻¹) (23)

where

$$β = \frac{{N}_{s}}{mean number of edges per state} . \qquad ( 24 )$$

With some careful trimming in the K_{T} system we can reduce the number of edges from (K_{T}·vᵢ^{d})²=361 to 39 and reduce the complexity of the scheduling algorithm to the order of 10⁵. Note that this is still worst-case (no removal of paths through domination) so in practice the complexity of the scheduling algorithm is lower than this. For a fully connected trellis (i.e. worst-case) the BCJR algorithm has complexity in the order of

O(η²κ) (25)

where η is the number of states in the 3GPP convolutional code trellis and κ is the number of trellis transitions. In our 3GPP compliant system there are two edges per state in the trellis so the BCJR algorithm has complexity O(2ηκ). Since η=8 and κ=3856 the MAP decoder in the CDMA receiver in FIG. 1 therefore has complexity in the order of 10⁴. The proposed scheduling algorithm has (in the worst case) complexity one order of magnitude higher than that of one BCJR algorithm activation in the decoder. Remembering that one TD iteration requires two activations of the BCJR algorithm, in the worst-case the savings outweigh the cost if the scheduling algorithm can save at least five TD iterations.

Simulation results of the IMUD receiver will now be described.

Unless specified otherwise, all BER values are the system average, calculated as

$${\hat{P}}_{b} = \frac{1}{{K}_{T }} {\sum }_{k = 1}^{L} {K}_{k} {\hat{P}}_{b , k} , \qquad ( 26 )$$

where \hat{P}_{b,k} is the estimated BER for group k. We simulated two systems with K_{T}=60 users and spreading factor N=30, first with equal power (i.e. un-optimized) then with the optimized power levels for N_{K}=3 power groups as described above. We define the 4-iteration threshold as the SNR required to allow convergence within 4 receiver iterations. Note that the optimization algorithms and thresholds are defined such that all user groups achieve the target BER.

Recall that in general P_{ref}=P₁, we calculate the average SNR as

$${\overline{E}}_{b} / {N}_{0} = \frac{1}{{N}_{K}} {\sum }_{k = 1}^{L} {K}_{k} ( \frac{{P}_{ref}}{{N}_{0 }} + 10 {log}_{10} ( \frac{{P}_{k}}{{P}_{ref}} ) ) , \qquad ( 27 )$$

where P_{ref}/N₀ is in dB, which we use to compare systems with different power profiles P.

### A. Equal Power System

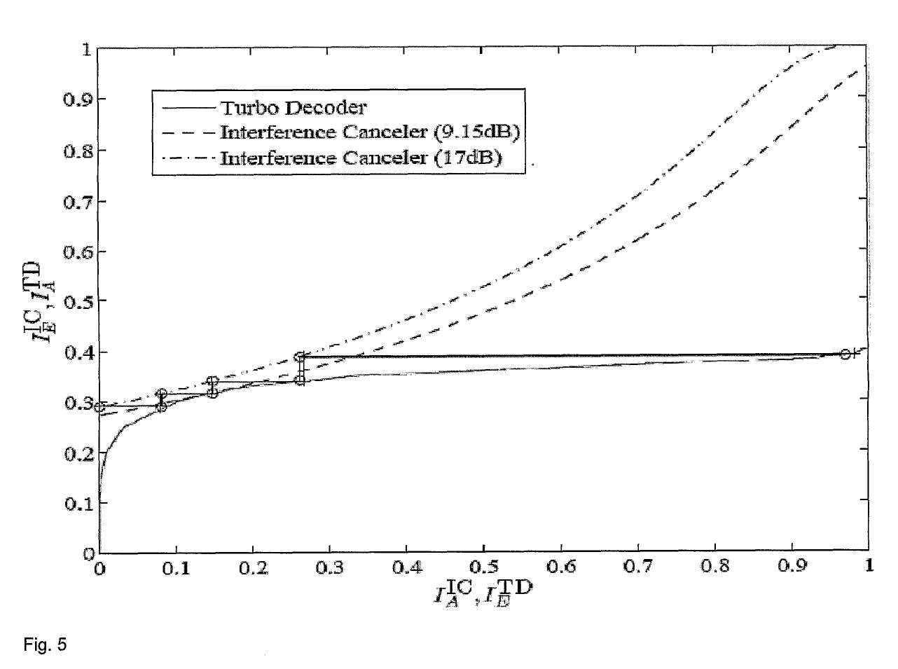

We consider a heavily loaded (K=[60], P=[1], N=30) equal power system. EXIT chart analysis in FIG. 5 shows the convergence threshold (dashed line) occurs at an SNR of P_{ref}/N₀=Ē_{b}/N₀=9.17 dB and the 4-iteration threshold (dot-dashed line) at 17 dB. We observe that the EXIT characteristics of the TD cause the bottleneck in this equal power system. The receiver would exhibit a sharp drop in BER over iterations once decoding has progressed through the narrow tunnel.

### B. Optimized System

A turbo coded unequal power CDMA system was simulated with K=[20,20,20] users, spreading factor N=30 and optimized power P=[1, 1.5381, 2.3917]. According to EXIT chart analysis in FIG. 3 the convergence threshold of this system is at P_{ref}/N₀=1.06 dB (average SNR Ē_{b}/N₀=2.95 dB) and the 4-iteration threshold is at P_{ref}/N₀=3.95 dB. We simulated the system over a range of SNR in the region of the 4-iteration threshold. Note that if P was optimized with a constraint on Δ in (14) to be sufficiently large to allow convergence within 4 receiver iterations we obtain the same relative result P′ but higher P₁=P_{ref}, such that P_{ref}/Nₙ=3.95 dB as above. Using (27) the average SNR at the 4-iteration threshold is Ē_{b}/N₀=5.84 dB. which corresponds to a 8.46 dB gain over the equal power system.

As suggested in [5], the optimal schedule at the convergence threshold was chosen for all P_{ref}/N₀ in the simulation. This schedule will be referred to as the static (optimal) schedule. We set the full decoding schedule as all groups running 6 TD iterations and 4 receiver iterations.

The corresponding EXIT chart snapshot trajectories are shown in FIG. 3 at P_{ref}/N₀=3.95 dB. Both snapshot trajectories match quite closely with EXIT chart analysis. Since the EXIT functions described above assume a large-scale system (PDF of MAI is approximately Gaussian) and the block length is finite, we expect some performance differences between this system and the asymptotic performance predicted.

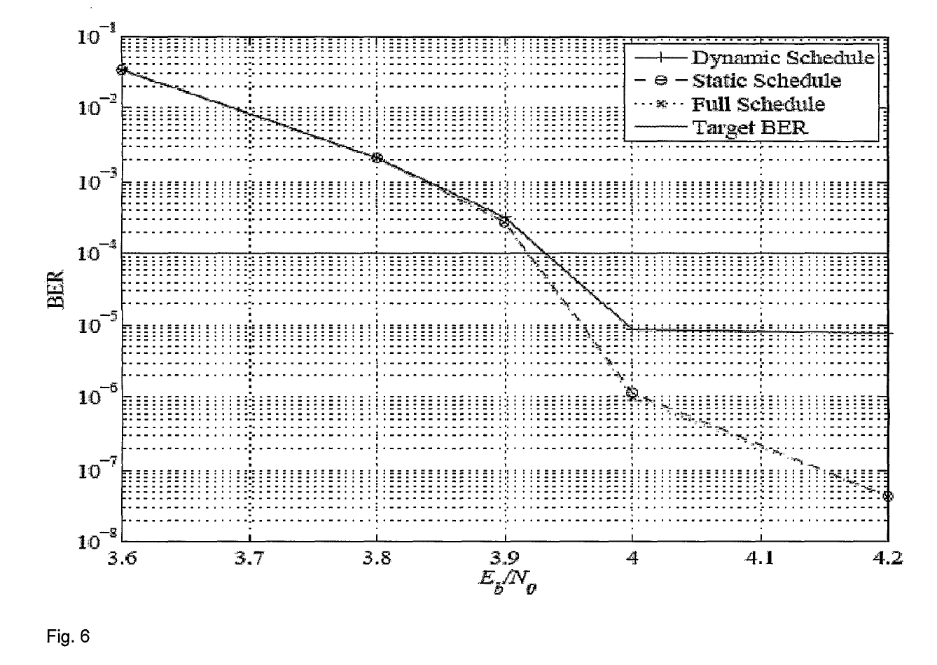

BER performance is plotted versus SNR in FIG. 6, where we see that BER performance of the dynamic schedule is very similar to that for the full decoding schedule up to the convergence threshold. The target BER P_{target} is 10⁻⁴ so dynamic scheduling exhibits an error floor below P_{target}, for SNR above the convergence threshold. Note that the error floor is not exactly equal to P_{target}, which is due to the shape of the TD EXIT function. As seen in FIG. 3, the TD EXIT function approaches high values of I_{E}^{TD} close to horizontally, so there is a very sharp drop from high to very low BER.

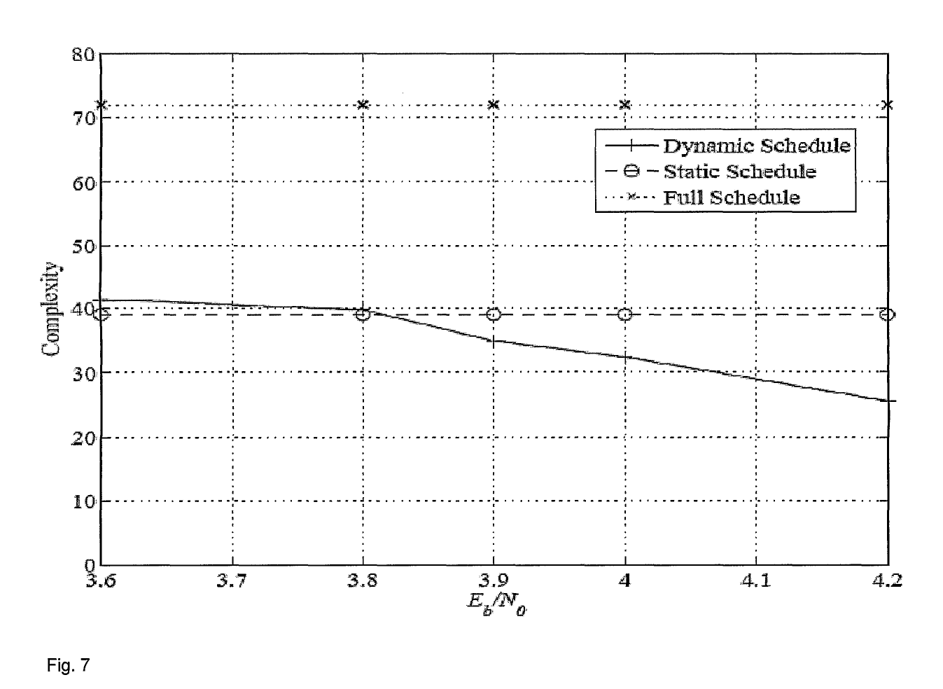

We observe that static scheduling also achieves very similar BER performance despite the static schedule being optimized only for the convergence threshold. This can be easily understood using the EXIT chart FIG. 3 and the EXIT function for the TD at low I_{A}^{TD}. At low SNR the IC and TD EXIT functions intersect at low I_{A,eff}^{TD} and in this region the TD EXIT function is very similar for all i^{d}. Therefore the system will come close to the convergence point following almost any schedule. If we consider an EXIT chart BER contour plot [4], at low values of MI the BER contours are widely spaced, i.e. large gain in MI achieve only a small improvement in BER, thus very little difference in BER will be seen between schedules in these cases. For high SNR the tunnel between the EXIT functions opens further so decoding following any schedule optimized for low SNR (i.e. a narrow tunnel) will easily step through the tunnel. This is inefficient as similar BER performance can be achieved with less TD/receiver iterations and explains why dynamic scheduling significantly reduces complexity at high SNR. This can be seen in FIG. 7, where we show the complexity required to achieve the corresponding BERs from FIG. 6. The static schedule achieves approximately a 45% reduction in complexity for similar BER performance as the full schedule. Using dynamic scheduling further savings in complexity are achieved, with savings increasing with SNR up to 64% compared to the full schedule at 4.2 dB. Note that below the convergence threshold dynamic scheduling uses more TD iterations than the static schedule. This is only due to the fact that the static schedule is derived at the convergence threshold.

An ARQ scheme could be investigated as possible extension of this work, as complexity could be further reduced for packets where P*>P_{target} by discarding the packet. Note the presence of an error floor for dynamic scheduling for E_{b}/N₀≦4 dB (i.e. above the convergence threshold), which is due to the target BER defined in the scheduling algorithm. The error floor is approximately equal to P_{target}.

We note in FIG. 6 that the BER performance for dynamic and static scheduling is approximately equal. However, while the mean BER is equal the variance is less for dynamic scheduling. As a result, using dynamic scheduling less packets (data blocks) fail to achieve the target BER. Specifically, at 4 dB for example, 96.5% of packets achieved the target while static scheduling achieved the target in only 86.9% of packets.

### C. Power vs Complexity

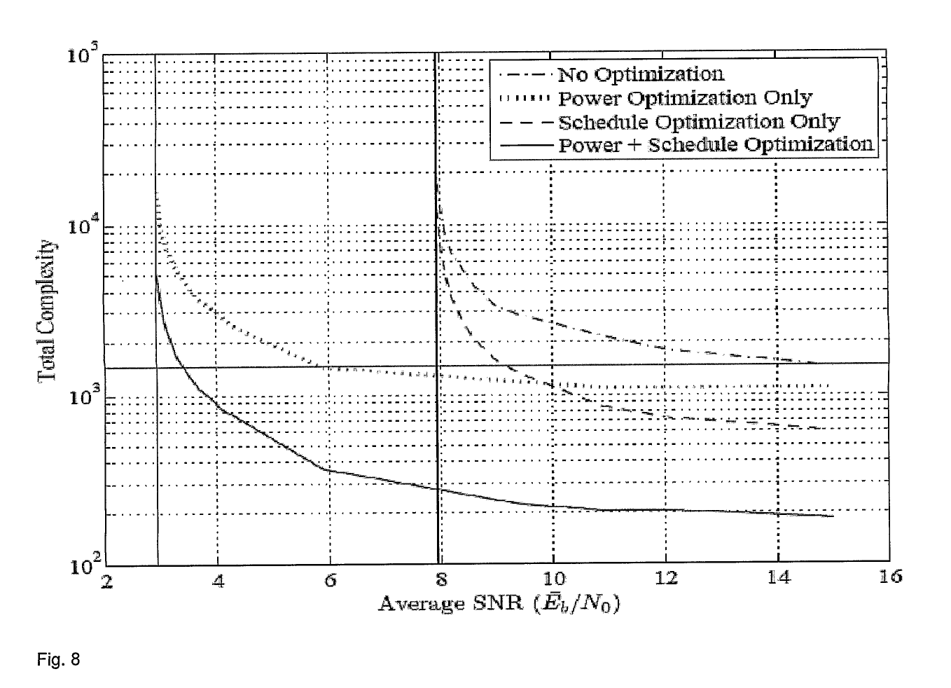

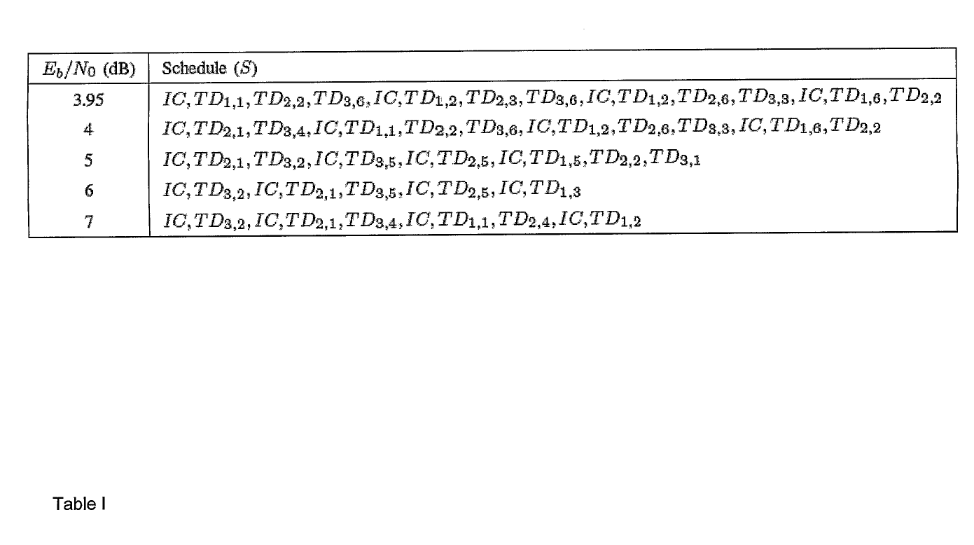

In FIG. 8 we show the complexity required to achieve a target BER P_{target} of 10⁻⁴ in a CDMA system with K_{T}=60 users and processing gain N=30. This graph allows the user to select a complexity vs power trade-off.

As average SNR is decreased more iterations are required to achieve convergence and vice versa. We show four cases in FIG. 8,
No Optimization: equal power and no scheduling; i^{d}=6 and iterate receiver until no further decrease in BER
Power Optimized: P=P′ and no scheduling; i^{d}=6 and iterate receiver until no further decrease in BER
Schedule Optimized: equal power and dynamic scheduling
Power+Schedule Optimized: P=P′ and dynamic scheduling.

Total complexity is shown on the y-axis where total complexity is calculated as

$${C}_{total} = \{ \begin{matrix}{\sum }_{k = 1}^{{N}_{K}} {K}_{k} \cdot {i}^{d} \cdot {i}^{r} & without scheduling \\ {\sum }_{k = 1}^{{N}_{K}} {K}_{k} \cdot {i}^{d} \cdot {i}^{r} + φ & with scheduling . \end{matrix} \qquad ( 28 )$$

where φ=5 is obtained using the results in described above. In the no optimization case (K=[60]. P=[1]), shown by the dot-dashed line, we see the convergence threshold occurs at an average SNR of Ē_{b}/N₀=9.15 dB and the complexity Cₜₒₜₐₗ is high. If the users are split into 3 equal size groups and the power levels are optimized as above, K=[20, 20, 20] and P=[1, 1.5381, 2.3917], we obtain the dotted line in FIG. 8. The convergence threshold is reduced such that P_{target} is achieved at an average SNR of Ē_{b}/N₀=2.95 dB, however, the complexity remains high.

If alternatively the schedule is optimized the complexity can be reduced by more than 50% as shown by the dashed line. As each user has equal power the convergence threshold remains unchanged from the no optimization case. The solid line shows the performance of the power and schedule optimized receiver, which we see has significant complexity and power gains over the conventional receiver. Note there is no trade-off made between complexity and power. The receiver is able to operate more efficiently in the lower left region of FIG. 8.

The convergence threshold is the vertical asymptote to the left of each curve, where complexity grows towards infinity. The average SNR of each asymptote in FIG. 8 corresponds to the SNR at which the two component EXIT functions intersect in the EXIT charts. The upper left end of the no optimization curve (dot-dash) in FIG. 8 corresponds to the lower TD EXIT function in FIG. 5. While successful decoding is possible, the tunnel is narrow and a large number of iterations are required to achieve convergence. Similarly, in the power optimized system (dots), the upper left end of the curve corresponds to the lower TD EXIT function in FIG. 3.

The horizontal line in FIG. 8 corresponds to the 4-iteration threshold where the normalized complexity is equal to Cₜₒₜ=1440 TD iterations, where i^{d}=6 and i^{r}=4 which are assumed to be reasonable values in consideration of a practical system. According to the upper TD EXIT function in FIG. 5 the 4-iteration threshold occurs at 17 dB in the equal power system. This corresponds to the point the no optimization curve intersects with the 4-iteration threshold at Ē_{b}/N₀=17 dB. The power optimized system achieves the target BER P_{target} in 4 receiver iterations at an average SNR of Ē_{b}/N₀=5.84 dB which is seen in FIG. 8 where the power optimized curve crosses the horizontal 4-iteration threshold line. This point is represented by the upper TD EXIT function in FIG. 3. For the schedule optimized curves the complexity represents the total average receiver complexity, it is not possible to infer the number of receiver iterations as i^{r} and i^{d} are dynamically allocated by the algorithm.

It will be appreciated by persons skilled in the art that numerous variations and/or modifications may be made to the invention as shown in the specific embodiments without departing from the scope of the invention as broadly described.

For example, the invention can also be applied to a number of other systems not limited to Mulitple-Input Multiple-Output (MIMO) systems, Orthogonal Frequency Division Multiplexing (OFDM), Orthogonal Frequency Division Multiple Access (OFDMA) and Interleave Division Multiple Access (IDMA).

The present embodiments are, therefore, to be considered in all respects as illustrative and not restrictive.

### REFERENCES

[1] G. Caire, R. Muller, and T. Tanaka, “Iterative multiuser joint decoding: Optimal power allocation and low-complexity implementation,” IEEE Trans. Info. Theory, vol. 50, no. 9, pp. 1950-1973, September 2004.
[2] C. Schlegel and Z. Shi, “Optimal power allocation and code selection in iterative detection of random CDMA,” in Zurich Seminar on Communications, Zurich, Switzerland, February 2004.
[3] G. Caire and R. Muller, “The optimal received power distribution for IC-based iterative multiuser joint decoders,” in Allerton Conference Comm. Control and Computing, Monticello, U.S.A., October 2001.
[4] S. ten Brink, “Convergence behavior of iteratively decoded parallel concatenated codes,” IEEE Trans. Commun., vol. 49, no. 10, pp. 1727-1737, October 2001.
[5] F. Brannstrom, L. K. Rasmussen, and A. J. Grant, “Convergence analysis and optimal scheduling for multiple concatenated codes,” IEEE Trans. Info. Theory, vol. 51, pp. 3354-3364, September 2005.
[6] D. P. Shepherd, F. Brannstrom, and M. C. Reed, “Minimising complexity in iterative multiuser detection using dynamic decoding schedules,” in Proc. IEEE Int. Workshop on Sig. Proc. Advanced in Wireless Communications, Cannes, France, 2006.
[7] K. Li and X. Wang, “EXIT chart analysis of turbo multiuser detection,” IEEE Transactions on Wireless Communications, vol. 4, no. 1, pp. 300-311, January 2005.
[8] J. W. Lee and R. E. Blahut, “Convergence analysis and BER performance of finite-length turbo codes,” IEEE Trans. Commun., vol. 55, no. 5, pp. 1033-1043, May 2007.
[9] D. P. Shepherd, F. Schreckenbach, and M. C. Reed, “Optimization of unequal power coded multiuser DS-CDMA using extrinsic information transfer charts,” in Proc. Conf. Information Sciences and Systems, Baltimore, U.S.A., March 2006.
[10] D. P. Shepherd, F. Brannstrom, and M. C. Reed, “Dynamic scheduling for a turbo CDMA receiver using EXIT charts,” in Proc. Aust. Commun. Theory Workshop, Adelaide, Australia, February 2007.
[11] P. D. Alexander, A. J. Grant, and M. C. Reed, “Performance analysis of an iterative decoder for code-division multiple-access,” European Trans. on Telecom., vol. 9, no. 5, pp. 419-426, September/October 1998.
[12] “3GPP TS 25.104 V5.9.0; 3rd generation partnership project;technical specification group radio access network;base station (BS) radio transmission and reception (FDD) (release 5),” September 2004.
[13] D. P. Shepherd, Z. Shi, M. Anderson, and M. C. Reed, “EXIT chart analysis of an iterative receiver with channel estimation,” in IEEE Global Telecommunications Conference, 2007.
[14] Z. Shi and C. Schlegel, “Performance analysis of iterative detection for unequal power coded CDMA systems,” in Proc. IEEE Globecom, December 2003, vol. 3, pp. 1537-1542.
[15] D. P. Shepherd, F. Brannstrom, and M. C. Reed, “Fidelity charts and stopping/termination criteria for iterative multiuser detection,” 4th International Symposium on Turbo Codes and Related Topics, 2006.
[16] F. Brannstrom, Convergence Analysis and Design of Multiple Concatenated Codes, Ph.D. thesis, Chalmers University of Technology, Goteborg, Sweden, 2004.
[17] M. Tuchler and J. Hagenauer, “EXIT charts of irregular codes,” in Conf. Information Sciences and Systems, 2002.
[18] F. Schreckenbach and G. Bauch, “Bit-interleaved coded irregular modulation,” European Transactions on Telecommunications, 2006.
[19] T. F. Coleman and Y. Li, “An interior, trust region approach for nonlinear minimization subject to bounds,” SIAM Journal on Optimization, vol. 6, pp. 418-445, 1996.
[20] T. F. Coleman and Y. Li, “On the convergence of reflective newton methods for large-scale nonlinear minimization subject to bounds,” Mathematical Programming, vol. 67, no. 2, pp. 189-224,1996.
[21] V. Franz and J. B. Anderson, “Concatenated decoding with a reduced-search BCJR algorithm,” IEEE Journal on Selected Areas in Communications, vol. 16, no. 2, pp. 186-195, February 1998.
[22] U. Dasgupta and K. R. Narayanan, “Parallel decoding of turbo codes using soft output T-algorithms,” IEEE Commun. Lett., vol. 5, no. 8, pp. 352-354, August 2001.

1. A method for power and decoding schedule optimization at a base station in communication with a plurality of users in a wireless network, the method comprising the steps of:
(i) deriving an extrinsic information transfer (EXIT) function for an interference canceller and a plurality of decoders at the base station, each decoder being associated with a user;
(ii) determining a power level for each of the plurality of users based on the derived EXIT functions; and then
(iii) deriving a decoding schedule for the plurality of decoders based on the derived EXIT functions and determined power levels.

2. A method according to claim 1, wherein the EXIT function represents the transfer function of a group of users with different power, code rate or modulation.

3. A method according to claim 1, wherein an effective EXIT function is determined for an interference canceller of the base station.

4. A method according to claim 1, wherein an effective EXIT function is determined for a turbo decoder using Monte Carlo simulation.

5. A method according to claim 1, wherein step (i) is based on predetermined or dynamic decoding statistics of all user groups.

6. A method according to claim 1, wherein step (ii) produces a power optimized EXIT chart that is then used in step (iii).

7. A method according to claim 6, wherein step (ii) is based on a convergence analysis of the EXIT chart, that is minimizing a threshold given a total power by optimizing the distribution of power among the users.

8. A method according to claim 1, wherein the users are divided into multiple groups where each member of the group has equal power.

9. A method according to claim 1, wherein step (iii) is uses both an off-line initialization and a on-line Viterbi search.

10. A method according to claim 9, wherein off-line initialization comprises determining a convergence point which is the intersection of a decoder EXIT curve with a interference canceller EXIT curve, and then determining a convergence bit error rate P*=Q(J⁻¹(I*_{D})/2) where P is the optimized power profile, Q(·) is the tail probability of the normalized Gaussian distribution, J( ) describes mutual information as a function of variance, and I*_{D} is the convergence point.

11. A method according to claim 9, wherein complexity of step (iii) can be reduced by performing any one or more of
trimming the trellis of a Viterbi search;
reducing the number of survivor paths of a Viterbi search truncating the number of allowed decoder iterations, and performing step (iii) less frequently than every iteration of the receiver.

12. A method according to claim 1, wherein the step (iii) is derived initially or after a predetermined number of interference canceller activations.

13. A method according to claim 1, wherein step (iii) comprises both static and dynamic scheduling processes.

14. A method according to claim 13, wherein the dynamic decoding schedule optimization comprises deriving for each iteration of the receiver the optimal schedule to achieve a target bit error rate using a minimum number of decoder iterations.

15. A method according to claim 1, wherein deriving the EXIT function of step (i) is further for a channel estimator and the decoding schedule of step (iii) is further for the channel estimator.

16. A base station for power and decoding schedule optimization, the base station being in communication with a plurality of users in a wireless network, the base station comprising:
an interference canceller;
a plurality of decoders, each decoder being associated with a user;
processing means to derive an extrinsic information transfer (EXIT) function for the interference canceller and the plurality of decoders at the base station;
a power optimization module to determine a power level for each of the plurality of users based on the derived EXIT functions; and
a schedule optimisation module to determine a decoding schedule for the plurality of decoders based on the derived EXIT functions and determined power levels.

17. Software, that when installed is able to cause the base station to perform the method according to claim 1.

18. A decoding schedule derived by the method of claim 1.
